(19) United States
(12) Patent Application Publication
(10) Pub. No.: US 2014/0274674 A1
(43) Pub. Date: Sep. 18, 2014

(54) Influence of Support Oxide Materials on Coating Processes of ZPGM Catalyst Materials for TWC Applications

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTi, Ventura, CA (US)

(21) Appl. No.: 14/183,081

(22) Filed: Feb. 18, 2014

Related U.S. Application Data
(63) Continuation-in-part of application No. 13/927,850, filed on Jun. 26, 2013.
(60) Provisional application No. 61/791,721, filed on Mar. 15, 2013.
(60) Provisional application No. 61/791,838, filed on Mar. 15, 2013.

(51) Int. Cl. B01J 23/889

(52) U.S. Cl. CPC B01J 23/8892
USPC 502/302; 502/349; 502/324

(57) ABSTRACT

The influence of a plurality of support oxides on coating process for ZPGM catalysts is disclosed. ZPGM catalyst samples with washcoat on suitable ceramic substrate and overcoat including a plurality of support oxides are prepared including an impregnation layer of Cu—Mn spinel or overcoat may be prepared from powder of Cu—Mn spinel with support oxide. Testing of fresh and aged ZPGM catalyst samples is developed under isothermal steady state sweep test condition. Catalyst testing allows to determine effect of a plurality of support oxides on coating processes, TWC performance, and stability of ZPGM catalysts for a plurality of TWC applications. Stability of ZPGM-TWC systems may be improved by promotion of the activity of ZPGM materials incorporating support oxides. Improvements that may be provided by the combination of support oxides with ZPGM materials in the catalyst may lead to a most effective utilization of ZPGM materials in TWC converters.

### CROSS-REFERENCE TO RELATED APPLICATIONS

This application is a continuation-in-part of U.S. patent application Ser. No. 13/927,850, filed Jun. 26, 2013, respectively, and claims priority to U.S. Provisional Application Nos. 61/791,721 and 61/791,838, filed Mar. 15, 2013, respectively, and is related to U.S. patent application Ser. No. 14/090,861, filed Nov. 26, 2013, entitled System and Methods for Using Synergized PGM as a Three-Way Catalyst, which are incorporated herein by reference as if set forth in their entirety.

### BACKGROUND

1. Field of the Disclosure

This disclosure relates generally to catalyst materials and, more particularly, to the effect of support oxide materials on coating processes of Zero-PGM catalyst materials for three-way catalyst (TWC) applications.

2. Background Information

Preparation of supported catalysts involves several important steps, such as choice of appropriate catalyst support, choice of method of deposition of the active phase, and catalyst promotion, amongst others. As catalyst performance depends on the methods of preparation, properties of the catalyst, number of metal sites, their characteristics and localization on the support can be controlled by promotion with noble metals and oxides. Addition of oxide promoters can modify the catalyst texture and porosity, increase dispersion, reducibility, and fraction of different metal crystalline phases, enhance mechanical resistance, and improve chemical stability of the support.

As catalysts attributes of activity, stability, selectivity, and regenerability can be related to the physical and chemical properties of the catalyst materials, which in turn can be related to the parameters in the method of preparation of the catalyst, the slurry characteristics of materials used are influential to the coating properties. The influence on coating properties can be effected in terms of support oxides.

Current three-way catalyst (TWC) systems include a support of alumina upon which both platinum group metals (PGM) material and promoting oxides are deposited. Key to the desired catalytic conversions is the structure-reactivity interplay between the promoting oxide and the PGM metals, in particular regarding the storage/release of oxygen under process conditions, but a set of characteristic variables drive up PGM cost, i.e., small market circulation volume, constant fluctuations in price, and constant risk to stable supply, amongst others.

According to the foregoing, there may be a need to provide support oxide materials for PGM-free catalyst systems which may be manufactured cost-effectively, such that catalytic performance may be improved by coating processes for the realization of suitable PGM-free catalytic layers in catalyst structures.

### SUMMARY

It is an object of the present disclosure the application of catalyst active components on a plurality of support oxide materials. For catalysts, in a highly dispersed and active form aiming at improving catalyst stability, a more effective utilization of the PGM-free catalyst materials and the plurality of support oxide materials may be achieved when expressed as a function of the coating process and effect of the employed support oxide components.

According to embodiments in present disclosure, a ZPGM catalyst configuration may include at least a substrate, a washcoat (WC) layer, an overcoat (OC) layer and an impregnation layer. A plurality of coating processes may be used to configure ZPGM catalysts, including a plurality of support oxide materials such as support oxides of aluminum, titanium, zirconium, in which WC layer may be an alumina-based washcoat coated on a suitable ceramic substrate, overcoat layer (OC) layer may include a plurality of support oxide materials, and an impregnation (IMP) layer including stoichiometric Cu—Mn spinel; or the catalyst system may include an alumina-based WC layer coated on a suitable ceramic substrate, and an OC layer which may be formed from bulk powder of Cu—Mn spinel with a support oxide.

In present disclosure, either Niobium-Zirconium oxide or Praseodymium-Zirconium oxide may be used as support oxide of OC layer. In addition, incipient wetness (IW) technique, or co-precipitation, or any other synthesis method known in the art may be employed for preparing powder to be used for OC layer.

The influence of the plurality of support oxide materials may be verified preparing fresh, hydrothermally aged, and fuel cut aging condition ZPGM catalyst samples, according to catalyst formulations in present disclosure.

The NO/CO cross over R-value of prepared fresh and aged ZPGM catalyst samples, per support oxide and coating process employed in present disclosure, may be determined and compared by performing isothermal steady state sweep test. The isothermal steady state sweep test may be developed at a selected inlet temperature using an 11-point R-value from rich condition to lean condition at a plurality of space velocities. Results from isothermal steady state test may be compared to show the influence of support oxide materials on coating process and TWC performance, under a range of rich condition to lean condition.

According to an embodiment, catalyst stability may be verified from the influence of the plurality of support oxide materials in present disclosure, using hydrothermally aged or fuel cut aged ZPGM catalyst samples at a plurality of aging temperatures. Under isothermal steady state sweep condition, the NO/CO conversion of aged ZPGM catalyst samples may be determined to compare activity level and verify catalyst stability that may result from the influence of the plurality of support oxide materials.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 corresponds to a catalyst configuration for ZPGM catalyst samples, including alumina-based washcoat on substrate, overcoat with doped ZrO₂, and impregnation layer of Cu—Mn spinel, according to an embodiment.

FIG. 2 represents a catalyst configuration for ZPGM catalyst samples, including alumina-based washcoat on substrate and overcoat formed from powder of Cu—Mn spinel on ZrO₂, according to an embodiment.

FIG. 3 depicts catalyst performance for fresh ZPGM catalyst samples of Example#1, under isothermal steady state sweep condition, at inlet temperature of about 450° C. and space velocity (SV) of about 40,000 h⁻¹, according to an embodiment.

FIG. 4 illustrates catalyst performance for fresh ZPGM catalyst samples of Example#2, under isothermal steady state sweep condition, at inlet temperature of about 450° C. and SV of about 40,000 h⁻¹, according to an embodiment.

FIG. 5 shows catalyst performance for fresh ZPGM catalyst samples of Example#3, under isothermal steady state sweep condition, at inlet temperature of about 450° C. and SV of about 40,000 h⁻¹, according to an embodiment.

FIG. 6 illustrates catalyst performance comparison for fuel cut aged (at about 800° C., for about 20 hours) ZPGM catalyst samples of Example#1 and Example#2, under isothermal steady state sweep condition at inlet temperature of about 450° C. and SV of about 40,000 h⁻¹, according to an embodiment.

FIG. 7 depicts catalyst performance comparison for hydrothermally aged (at about 900° C., for about 4 hours) ZPGM catalyst samples of Example#1 and Example#2, under isothermal steady state sweep condition at inlet temperature of about 450° C. and SV of about 40,000 h⁻¹, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Milling” refers to the operation of breaking a solid material into a desired grain or particle size.

“Impregnation” refers to the process of imbuing or saturating a solid layer with a liquid compound or the diffusion of some element through a medium or substance.

“Incipient wetness” refers to the process of adding solution of catalytic material to a dry support oxide powder until all pore volume of support oxide is filled out with solution and mixture goes slightly near saturation point.

“Calcination” refers to a thermal treatment process applied to solid materials, in presence of air, to bring about a thermal decomposition, phase transition, or removal of a volatile fraction at temperatures below the melting point of the solid materials.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### DESCRIPTION OF THE DRAWINGS

The present disclosure may provide material compositions including Cu—Mn spinel on a plurality of support oxides and their effect on coating processes to develop suitable catalytic layers, which may ensure the identification of support oxide materials, capable of providing effective catalytic activity and stability. Aspects that may be treated in present disclosure may show improvements in the process for effective catalytic conversion capacity of a plurality of ZPGM catalysts, which may be suitable for TWC applications.

Catalyst material composition and configuration

As catalyst performance may be translated into the physical catalyst structure, different materials compositions may be formulated and prepared, including stoichiometric Cu—Mn spinel and a plurality of support oxide materials, to determine the influence of the support oxide materials on a plurality of coating processes as known in the art. In present disclosure, a plurality of doped Zirconia support oxide may be used in a plurality of catalyst configurations.

FIG. 1 shows a catalyst configuration 100 for ZPGM catalyst samples, including alumina, Cu_{1.0}Mn_{2.0}O₄ spinel, and a plurality of support oxide materials, which may be prepared employing a plurality of coating processes, according to an embodiment.

In this configuration washcoat (WC) layer 102 may be alumina only, coated on suitable ceramic substrate 104.

Impregnation technique may be used for applying an impregnation (IMP) layer 108 of Cu_{1.0}Mn_{2.0}O₄ spinel on overcoat (OC) layer 106 of doped ZrO₂ support oxide, which may be coated on alumina-based WC layer 102 on ceramic substrate 104. Doped ZrO2 in present disclosure may be Nb₂O₅—ZrO₂ or Pr₆O₁₁—ZrO₂.

FIG. 2 shows a catalyst configuration 200 for ZPGM catalyst samples, including alumina, Cu_{1.0}Mn_{2.0}O₄ spinel, and a plurality of support oxide materials, which may be prepared employing a plurality of coating processes, according to an embodiment. In this configuration washcoat (WC) layer 102 may be alumina only, coated on suitable ceramic substrate 104.

Incipient wetness (IW) technique may be employed for preparing Cu_{1.0}Mn_{2.0}O₄ spinel with doped ZrO₂ support oxide to make fine grain bulk powder, which may be milled with water and subsequently coated on alumina-based WC layer 102 coated on ceramic substrate 104.

Aged ZPGM catalyst samples in present disclosure may be prepared by hydrothermal aging employing about 10% steam/air at a plurality of temperatures within a range from about 800° C. to about 1,000° C. for a polarity of duration, such as 4 hours. Additionally, aged catalyst samples may be prepared under fuel cut aging condition. Commercial aging of catalyst samples may be performed at a temperature of about 800° C. for about 20 hours, with fuel gas including CO, O₂, CO₂, H₂O and N₂ as aging fuel feed running at moderate or high power.

The NO/CO cross over R-value of prepared fresh and aged ZPGM catalyst samples, per support oxide and coating process employed in present disclosure, may be determined and compared by performing isothermal steady state sweep test. The isothermal steady state sweep test may be developed at a selected inlet temperature using an 11-point R-value from rich condition to lean condition at a plurality of space velocities. Results from isothermal steady state test may be compared to show the influence of support oxide materials on coating process and TWC performance. The NO/CO cross over R-value of aged ZPGM catalyst samples may be also used to verify catalyst stability that may result from the effect of the plurality of support oxide materials.

Isothermal Steady State Sweep Test Procedure

The isothermal steady state sweep test may be carried out employing a flow reactor at inlet temperature of about 450° C., and testing a gas stream at 11-point R-values from about 2.00 (rich condition) to about 0.80 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NO_{R}, about 2,000 ppm of H₂, about 10% of CO₂, and about 10% of H₂O. The quantity of O₂ in the gas mix may be varied to adjust Air/Fuel (A/F) ratio within the range of R-values to test

The following examples are intended to illustrate the scope of the disclosure. It is to be understood that other procedures known to those skilled in the art may alternatively be used.

### EXAMPLES

### Example #1

IMP Layer of Cu_{1.0}Mn_{2.0}O₄ Spinel on OC Layer of Nb₂O₅—ZrO₂ Support Oxide

Example #1 may illustrate preparation of ZPGM catalyst samples of catalyst configuration 100 employing coating process including impregnation technique for IMP layer 108 of Cu_{1.0}Mn_{2.0}O₄ spinel on OC layer 106 of Nb₂O₅—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired (calcined) at about 550° C. for about 4 hours. Preparation of OC layer 106 may start by milling Nb₂O₅—ZrO₂ support oxide with water separately to make slurry. Suitable loading of Nb₂O₅—ZrO₂ support oxide may be about 120 g/L. Then, OC layer 106 may be coated on WC layer 102, followed by calcination at 550° C. for about 4 hours. Subsequently, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄. Then, Cu—Mn solution may be impregnated to OC layer 106, followed by firing at about 600° C. for about 5 hours.

In example #1, hydrothermally aged ZPGM catalyst samples may be aged at about 900° C. for about 4 hours and fuel cut aged ZPGM catalyst samples may be aged at a temperature of about 800° C. for about 20 hours.

FIG. 3 shows catalyst performance 300 for fresh ZPGM catalyst samples prepared per example #1, under isothermal steady state sweep condition, at inlet temperature of about 450° C. and SV of about 40,000 h⁻¹, according to an embodiment.

In FIG. 3, conversion curve 302, conversion curve 304, and conversion curve 306 respectively show isothermal steady state sweep test results for NO conversion, CO conversion and HC conversion.

As may be seen in FIG. 3, for fresh ZPGM catalyst samples, NO/CO cross over takes place at the specific R-value of 1.19, where NOₓ and CO conversions are about 98.5%, respectively. Activity under close to stoichiometric condition for fresh ZPGM catalyst samples, per example #1, may be observed at R-value of 1.10, where NOₓ conversion is about 94.6% and CO conversion is about 99.7%.

### Example #2

### IMP Layer of Cu_{1.0}Mn_{2.0}O₄ Spinel on OC Layer of Pr₆O₁₁—ZrO₂ Support Oxide

Example #2 may illustrate preparation of ZPGM catalyst samples of catalyst configuration 100 employing coating process including impregnation technique for IMP layer 108 of Cu_{1.0}Mn_{2.0}O₄ spinel on OC layer 106 of Pr₆O₁₁—ZrO₂ support oxide.

Preparation of WC layer 102 may start by milling alumina solution to make slurry. Suitable loading of alumina may be about 120 g/L. Alumina slurry may be subsequently coated on ceramic substrate 104 and fired at about 550° C. for about 4 hours. Preparation of OC layer 106 may start by milling Pr₆O₁₁—ZrO₂ support oxide with water separately to make slurry. Suitable loading of Pr₆O₁₁—ZrO₂ support oxide may be about 120 g/L. Then OC layer 106 may be coated on WC layer 102, followed by calcination at 550° C. for about 4 hours. Subsequently, Cu—Mn solution may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄. Then, Cu—Mn solution may be impregnated to OC layer 106, followed by calcination at about 600° C. for about 5 hours.

In example #2, hydrothermally aged ZPGM catalyst samples may be aged at about 900° C. for about 4 hours and fuel cut aged ZPGM catalyst samples may be aged at a temperature of about 800° C. for about 20 hours.

FIG. 4 depicts catalyst performance 400 for fresh ZPGM catalyst samples prepared per example #2, under isothermal steady state sweep condition, at inlet temperature of about 450° C. and SV of about 40,000 h⁻¹, according to an embodiment.

In FIG. 4, conversion curve 402, conversion curve 404, and conversion curve 406 respectively depict isothermal steady state sweep test results for NO conversion, CO conversion, and HC conversion.

As may be seen in FIG. 4, for fresh ZPGM catalyst samples, NO/CO cross over takes place at the specific R-value of 1.17, where NOₓ and CO conversions are about 99.4%, respectively.

Activity under close to stoichiometric condition for fresh ZPGM catalyst samples, per example #2, may be observed at R-value of 1.1, where NOₓ conversion is about 96.9% and CO conversion is about 99.7%.

Activity under close to stoichiometric condition for fresh ZPGM catalyst samples, per example #2, at R-value of 1.1 may be compared to activity at same R-value for fresh ZPGM catalyst samples, per example #1. At this R-value, NOₓ conversion of fresh ZPGM catalyst samples, per example #2, indicates a slight improvement in catalyst activity, showing effect of type of support oxide on NOₓ conversion when catalyst is fresh.

### Example #3

### OC Layer from Bulk Powder of Cu_{1.0}Mn_{2.0}O₄Spinel/Pr₆O₁₁—ZrO₂

Example #3 may illustrate preparation of ZPGM catalyst samples of catalyst configuration 200 employing coating process including incipient wetness technique for bulk powder including Cu_{1.0}Mn_{2.0}O₄ spinel/Pr₆O₁₁—ZrO₂ as OC layer 202.

Preparation of WC layer 102 may start by milling alumina solution to make slurry. Suitable loading of alumina may be about 120 g/L. Alumina slurry may be subsequently coated on ceramic substrate 104 and fired at about 550° C. for about 4 hours. Preparation of OC layer 202 may start by preparing Cu—Mn solution mixing the appropriate amount of Mn nitrate solution (Mn(NO₃)₂) and Cu nitrate solution (CuNO₃) with water to make solution at appropriate molar ratio for Cu_{1.0}Mn_{2.0}O₄. Then, Cu—Mn solution may be added to Pr₆O₁₁—ZrO₂ support oxide powder by incipient wetness method. Subsequently, mixture powder may be dried and calcined at about 600° C. for about 5 hours, and then ground to fine grain for bulk powder.

Bulk powder of Cu_{1.0}Mn_{2.0}O₄/Pr₆O₁₁—ZrO₂ support oxide may be milled with water separately to make slurry and then may be coated on WC layer 102 on ceramic substrate 104, followed by calcination at about 600° C. for about 5 hours. OC layer 202 suitable loading may be about 120 g/L.

FIG. 5 depicts catalyst performance 500 for fresh ZPGM catalyst samples prepared per example #3, under isothermal steady state sweep condition, at inlet temperature of about 450° C. and SV of about 40,000 h⁻¹, according to an embodiment.

In FIG. 5, conversion curve 502, conversion curve 504, and conversion curve 506 respectively depict isothermal steady state sweep test results for NO conversion, CO conversion, and HC conversion.

As may be seen in FIG. 5, for fresh ZPGM catalyst samples, NO/CO cross over takes place at the specific R-value of 1.29, where NOₓ and CO conversions are about 98.9%, respectively.

Activity under close to stoichiometric condition for fresh ZPGM catalyst samples, per example #3, may be observed at R-value of 1.10, where NOₓ conversion is about 70.9% and CO conversion is about 99.6%. Comparison of NOₓ conversion of ZPGM catalyst of Example#3 with other ZPGM catalysts of this disclosure indicates a significant reduction in catalyst activity when compared with activity, at same R-value of 1.10, for fresh ZPGM catalyst samples per example #1 and example #2, where NOₓ conversion observed is 94.6% and 96.9%, respectively. Comparison of NOₓ conversions may verify improved performance of fresh ZPGM catalyst samples prepared by IMP layer method in example #1 and Example#2. Performance of fresh ZPGM catalyst samples prepared according to formulation and coating processes in example #1, example#2, and example #3 may confirm the influence that a plurality of support oxides and type of coating process may have on catalytic activity.

Effect of Support Oxide on Thermal Stability of ZPGM Catalyst

FIG. 6 illustrates catalyst performance comparison 600 for aged ZPGM catalyst samples, under fuel cut aging at 800° C. for about 20 hours, including an IMP layer 108 of Cu—Mn spinel on OC layer 106 of Nb₂O₅—ZrO₂ support oxide (Example #1), and an IMP layer 108 of Cu—Mn spinel on OC layer 106 of Pr₆O₁₁—ZrO₂ support oxide (Example #2), under isothermal steady state sweep condition, according to an embodiment.

In FIG. 6, conversion curve 602 (line with solid rhombus) and conversion curve 604 (line with blank rhombus) respectively illustrates % NO conversion for fuel cut aged ZPGM catalyst samples per example #2 and example#1, conversion curve 606 (line with solid squares), and conversion curve 608 (line with blank squares), respectively illustrates % CO conversion for fuel aged ZPGM catalyst samples per example #2 and example #1.

As may be seen in FIG. 6, NO/CO cross over takes place at the specific R-values of 1.356 and 1.405 for aged ZPGM catalyst samples including Pr₆O₁₁—ZrO₂ support oxide (example #2) and Nb₂O₅—ZrO₂ support oxide (example #1), respectively. These results confirm that Pr₆O₁₁—ZrO₂ support oxide, per example #2, shows improved stability after aging ZPGM catalyst samples under fuel cut aging condition. Additionally, better NOₓ and CO conversion levels may be observed for aged ZPGM catalyst samples including Pr₆O₁₁—ZrO₂ support oxide.

FIG. 7 illustrates catalyst performance comparison 700 for ZPGM catalyst samples hydrothermally aged at about 900° C. for about 4 hours, including an IMP layer 108 of Cu—Mn spinel on OC layer of Nb₂O₅—ZrO₂ support oxide (Example #1), and an IMP layer 108 of Cu—Mn spinel on OC layer of Pr₆O₁₁—ZrO₂ support oxide (Example #2), under isothermal oscillating condition, according to an embodiment.

In FIG. 7, conversion curve 702 (line with solid rhombus) and conversion curve 704 (line with blank rhombus) respectively illustrates % NO conversion for hydrothermally aged ZPGM catalyst samples per example #2 and example #1, conversion curve 706 (line with solid squares), and conversion curve 708 (line with blank squares), respectively illustrates % CO conversion for hydrothermally aged ZPGM catalyst samples per example #2 and example #1.

As may be seen in FIG. 7, NO/CO cross over takes place at the specific R-values of 1.28 and 1.31 for hydrothermally aged ZPGM catalyst samples including Pr₆O₁₁—ZrO₂ support oxide (example #2) and Nb₂O₅—ZrO₂ support oxide (example #1), respectively. These results confirm that Pr₆O₁₁—ZrO₂ support oxide, per example #2, shows improved stability after hydrothermally aging ZPGM catalyst samples. Hydrothermally aged ZPGM catalyst samples including Pr₆O₁₁—ZrO₂ support oxide show improved NOₓ and CO conversion levels when compared to NOₓ and CO conversion levels for hydrothermally aged ZPGM catalyst samples including Nb₂O₅—ZrO₂ support oxide. Additionally, as may be observed from FIG. 6 and FIG. 7, hydrothermally aged ZPGM catalyst samples including Pr₆O₁₁—ZrO₂ support oxide may provide higher stability and improved TWC performance than ZPGM catalyst samples under fuel cut aging condition regardless of the type of support oxides that may be used in OC layer 106. These results may confirm the influence that a support oxide may have on TWC performance and stability of ZPGM catalyst samples after aging.

From the foregoing, it may be seen that stability of ZPGM-TWC systems may be improved by promotion of the activity of ZPGM materials incorporating support oxides. Improvements that may be provided by the combination of support oxides with ZPGM materials in the catalyst may lead to a most effective utilization of ZPGM materials in TWC converters.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic system, comprising:
a substrate;
a washcoat applied to said substrate comprising alumina;
at least one support oxide applied to said washcoat; and
at least on catalyst applied to the at least one support oxide;
wherein the at least one catalyst is substantially free of platinum group metals and wherein the at least one support oxide is selected from the group consisting of Nd₂O₅—ZrO₂, Pr₆O₁₁—ZrO₂, Pr—ZrO₂, and mixtures thereof.

2. The catalyst system of claim 1, wherein the substrate comprises ceramics.

3. The catalyst system of claim 1, wherein the at least one catalyst comprises comprises Cu and Mn.

4. The catalyst system of claim 1, wherein the at least one catalyst comprises a spinel structured compound.

5. The catalyst system of claim 1, wherein the at least one catalyst has a general formula of CuₓMn₃₋ₓO₄.

6. The catalyst system of claim 5, wherein x is at least 0.5.

7. The catalyst system of claim 1, wherein at least one catalyst is applied as an overcoat.

8. The catalyst system of claim 1, wherein the conversion of CO is greater than 98%.

9. The catalyst system of claim 1, wherein the conversion of NO, is greater than 70%.

10. The catalyst system of claim 1, wherein the conversion of NO, is greater than 98%.

11. The catalyst system of claim 1, wherein the at least one support oxide layer is calcinated at about 600° C. for about 5 hours.

12. The catalyst system of claim 1, wherein the washcoat comprises alumina at about 120 g/L.

13. A catalytic composition, comprising:
at least one catalyst substantially free of platinum group metals; and
at least one support oxide selected from the group consisting of Nd₂O₅—ZrO₂, Pr₆O₁₁—ZrO₂, Pr—ZrO₂, and mixtures thereof.
wherein the at least one catalyst comprises comprises Cu and Mn.

14. The catalyst composition of claim 13, wherein the at least one catalyst comprises a spinel structured compound.

15. The catalyst composition of claim 13, wherein the at least one catalyst has a general formula of CuₓMn₃₋ₓO₄.

16. The catalyst composition of claim 15, wherein x is at least 0.5.

17. The catalyst composition of claim 13, wherein the at least one catalyst catalyzes CO at greater than 98%.

18. The catalyst composition of claim 13, wherein the at least one catalyst catalyzes NOₓ at greater than 70%.

19. The catalyst composition of claim 13, wherein the at least one catalyst catalyzes NOₓ at greater than 98%.

20. The catalyst composition of claim 13, wherein the at least one catalyst and at least one support oxide are combined by the incipient wetness method.
